(19) United States
(12) Patent Application Publication
(10) Pub. No.: US 2025/0380004 A1
(43) Pub. Date: Dec. 11, 2025

(54) INHERITED TRANSFORM TYPE IN A MERGE CANDIDATE LIST

(71) Applicant: Tencent America LLC, Palo Alto, CA (US)

(72) Inventors: Lien-Fei CHEN, Palo Alto, CA (US); Roman CHERNYAK, Santa Clara, CA (US); Xin ZHAO, San Jose, CA (US); Xiaozhong XU, State College, PA (US); Shan LIU, San Jose, CA (US)

(73) Assignee: Tencent America LLC, Palo Alto, CA (US)

(21) Appl. No.: 19/301,863

(22) Filed: Aug. 15, 2025

Related U.S. Application Data
(63) Continuation of application No. PCT/US2024/025603, filed on Apr. 20, 2024.
(60) Provisional application No. 63/461,227, filed on Apr. 21, 2023.

(51) Int. Cl. H04N 19/61; H04N 19/105; H04N 19/12; H04N 19/159; H04N 19/176; H04N 19/513

(52) U.S. Cl. CPC H04N 19/61; H04N 19/159; H04N 19/176; H04N 19/521; H04N 19/105; H04N 19/12

(57) ABSTRACT

Methods and apparatuses for video decoding and video encoding and a method of processing visual media data are included. The apparatus for video decoding includes processing circuitry configured to receive coded information indicating that a current block is predicted according to a merge mode. When transform type information is to be inherited by the current block, the processing circuitry is configured to add the transform type information of a merge candidate and one of motion information and block vector (BV) information of the merge candidate into a merge candidate list of the current block and reconstruct the current block based on the merge candidate list. The merge candidate list includes the transform type information of the merge candidate and the one of the motion information and BV information of the merge candidate.

### RELATED APPLICATIONS

The present application is a continuation of International Application No. PCT/US2024/025603, filed on Apr. 20, 2024, which claims the benefit of priority to U.S. Provisional Application No. 63/461,227, “Inherited Transform Type In Merge Mode With Multiple Transform Type Selection” filed on Apr. 21, 2023. The entire disclosures of the prior applications are hereby incorporated herein by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include methods and apparatuses for video encoding/decoding.

In an aspect, a method of processing visual media data includes processing a bitstream of visual media data including a current block according to a format rule. The bitstream includes a first syntax element indicating whether transform type information is to be inherited by the current block that is predicted according to an inter merge mode. The format rule specifies that when the transform type information is determined to be inherited by the current block and multiple transform selection (MTS) is available to the current block, the transform type information of a merge candidate and motion information of the merge candidate is added into a merge candidate list of the current block. The format rule specifies that the current block is coded based on the merge candidate list. The merge candidate list includes the transform type information of the merge candidate.

In an example, the bitstream includes a second syntax element indicating a transform type of the current block. The format rule specifies that when the transform type information is determined not to be inherited by the current block. The current block is coded based on the transform type indicated by the second syntax element.

In an example, the motion information of the merge candidate indicates a motion vector (MV) and a reference picture, and the reference picture is different from a current picture of the current block.

In an example, the transform type information is determined to be inherited by the current block when one of (i) an area, (ii) a width, and (iii) a height of the current block satisfies a predefined condition.

In an aspect, a method for video encoding includes determining whether transform type information is to be inherited by a current block that is to be predicted according to a merge mode. The method for video encoding includes when the transform type information is determined to be inherited by the current block, adding the transform type information of a merge candidate and one of motion information and block vector (BV) information of the merge candidate into a merge candidate list of the current block. The method for video encoding includes encoding, in a bitstream, the current block based on the merge candidate list including the merge candidate and encoding, in the bitstream, a first syntax element indicating that the transform type information is to be inherited by the current block.

In an example, the method for video encoding includes determining that the transform type information is to be inherited when multiple transform selection (MTS) is available to the current block.

In an example, the merge mode is an inter merge mode, the motion information of the merge candidate indicates a motion vector (MV) and a reference picture, and the reference picture is different from a current picture of the current block.

In an example, the merge mode is an intra block copy (IBC) merge mode, and the merge candidate is from a neighboring intra template matching prediction (IntraTMP) block of the current block. The neighboring IntraTMP block is coded by an IntraTMP mode. The transform type information includes a transform type of the neighboring IntraTMP block, and the one of the motion information and the BV information includes a BV of the neighboring IntraTMP block.

In an example, the method for video encoding includes determining that the transform type information of the merge candidate is included in the merge candidate list when a block size of the current block satisfies one of: (i) an area of the current block is larger than or equal to W₁×H₁, (ii) the area of the current block is smaller than or equal to W₂×H₂, (iii) a width of the current block is larger than or equal to W₃, (iv) the width of the current block is smaller than or equal to W₄, (v) a height of the current block is larger than or equal to H₃, and (vi) the height of the current block is smaller than or equal H₄.

In an example, the method for video encoding includes when the transform type information is determined not to be inherited by the current block, encoding a second syntax element that indicates a transform type of the current block.

According to an aspect of the disclosure, an apparatus for video decoding includes processing circuitry. The processing circuitry is configured to receive coded information indicating that a current block is predicted according to a merge mode. When transform type information is to be inherited by the current block, the processing circuitry is configured to add the transform type information of a merge candidate and one of motion information and block vector (BV) information of the merge candidate into a merge candidate list of the current block. The processing circuitry is configured to reconstruct the current block based on the merge candidate list. The merge candidate list includes the transform type information of the merge candidate and the one of the motion information and BV information of the merge candidate.

In an example, the transform type information of the merge candidate is included in the merge candidate list when multiple transform selection (MTS) is available to the current block.

In an example, the merge mode is an inter merge mode, the motion information of the merge candidate indicates a motion vector (MV) and a reference picture, and the reference picture is different from a current picture of the current block.

In an example, the merge mode is an intra block copy (IBC) merge mode, and the merge candidate is from a neighboring intra template matching prediction (IntraTMP) block of the current block. The neighboring IntraTMP block is coded by an IntraTMP mode. The transform type information includes a transform type of the neighboring IntraTMP block. The one of the motion information and the BV information includes a BV of the neighboring IntraTMP block.

In an example, the transform type information of the merge candidate is included in the merge candidate list when a block size of the current block satisfies a condition.

In an example, the coded information includes a first syntax element indicating whether the transform type information is to be inherited by the current block. When the first syntax element indicates that the transform type information is not to be inherited by the current block, the coded information includes a second syntax element indicating a transform type of the current block, and the processing circuitry is configured to reconstruct the current block based on the transform type indicated by the second syntax element.

In an example, multiple transform selection (MTS) is available to the current block.

In an example, the merge mode is an intra block copy (IBC) merge mode. The merge candidate is from a neighboring intra template matching prediction (IntraTMP) block of the current block. The neighboring IntraTMP block is coded by an IntraTMP mode. The one of the motion information and the BV information includes a BV of the neighboring IntraTMP block, and the first syntax element indicates whether a transform type of the neighboring IntraTMP block is to be inherited by the current block.

In an example, the first syntax element indicating whether the transform type information is to be inherited by the current block is signaled when one of (i) an area, (ii) a width, and (iii) a height of the current block satisfies a predefined condition.

In an example, the merge mode is one of an inter merge mode, a skip mode, an intra block copy (IBC) merge mode, an IBC skip mode, an intra template matching prediction (IntraTMP) mode, and an affine merge mode.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows positions of spatial merge candidates according to an aspect of the disclosure.

FIG. 5 shows candidate pairs that are considered for a redundancy check of spatial merge candidates according to an aspect of the disclosure.

FIG. 6 shows an example of motion vector scaling for a temporal merge candidate according to an aspect of the disclosure.

FIG. 7 shows an example of candidate positions (e.g., C0 and C1) for a temporal merge candidate of a current CU according to an aspect of the disclosure.

FIG. 8 shows an example of a template matching (TM) mode according to an aspect of the disclosure.

FIG. 9 shows an example of a pattern of non-adjacent spatial merge candidates according to an aspect of the disclosure.

FIG. 10 shows examples of a template and a reference template including reference samples of the template for a current block with sub-block motion using the motion information of the subblocks of the current block according to an aspect of the disclosure.

FIG. 11 shows an example of zero candidates exclusion in an adaptive reordering of merge candidates with template matching (ARMC) process according to an aspect of the disclosure.

FIG. 12A shows an example of a block vector (BV) adjustment for a horizontal flip according to an aspect of the disclosure.

FIG. 12B shows an example of a BV adjustment for a vertical flip according to an aspect of the disclosure.

FIG. 13A shows an example of a transform coding process according to an aspect of the disclosure.

FIG. 13B shows examples of subblock transform (SBT) positions, SBT types, and respective transform types according to an aspect of the disclosure.

FIG. 14 shows a flow chart outlining a decoding process according to some aspects of the disclosure.

FIG. 15 shows a flow chart outlining an encoding process according to some aspects of the disclosure.

FIG. 16 is a schematic illustration of a computer system in accordance with an aspect.

### DETAILED DESCRIPTION

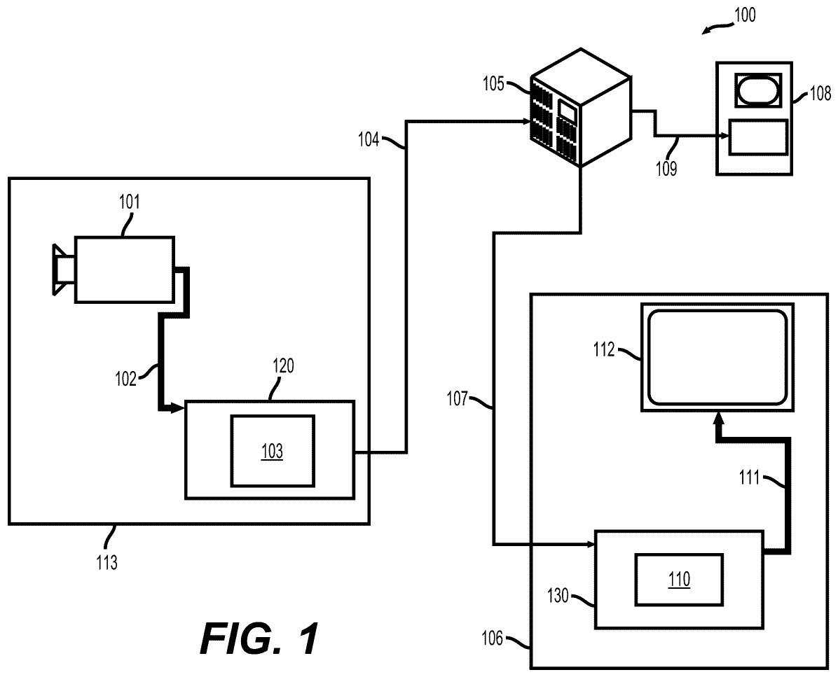

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

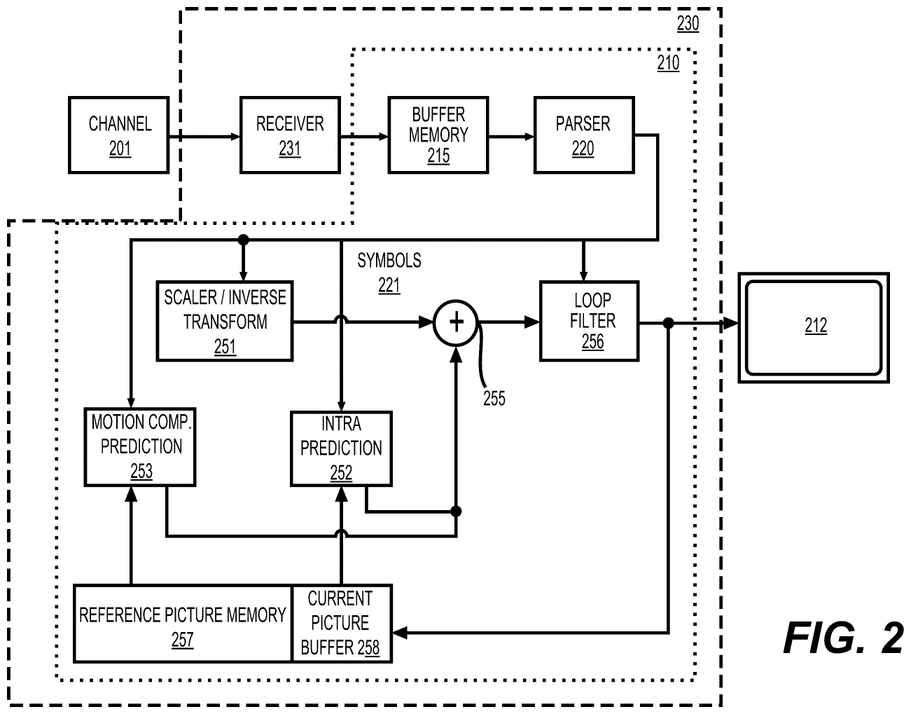

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

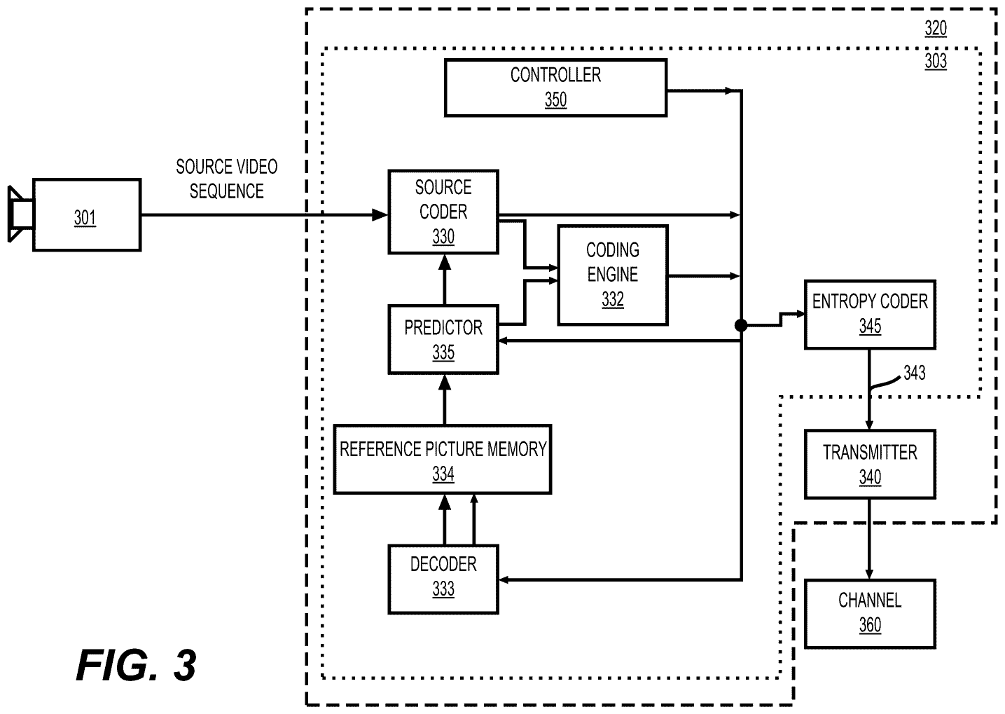

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode (e.g., a regular merge mode) technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Various inter prediction modes can be used, for example, in VVC. For an inter-predicted CU, motion parameters can include MV(s), one or more reference picture indices, a reference picture list usage index, and additional information for certain coding features to be used for inter-predicted sample generation. A motion parameter can be signaled explicitly or implicitly. When a CU is coded with a skip mode, the CU can be associated with a PU and can have no significant residual coefficients, no coded motion vector delta or MV difference (e.g., MVD) or a reference picture index. A merge mode (e.g., the regular merge mode) can be specified where the motion parameters for the current CU are obtained from neighboring CU(s), including spatial and/or temporal candidates, and in some aspects additional information such as introduced in VVC. The merge mode can be applied to an inter-predicted CU, not only for skip mode. In an example, an alternative to the merge mode is the explicit transmission of motion parameters, where MV(s), a corresponding reference picture index for each reference picture list and a reference picture list usage flag and other information are signaled explicitly per CU.

In an aspect, such as in VVC, VVC Test model (VTM) reference software includes one or more refined inter prediction coding tools that include: an extended merge prediction, a merge motion vector difference (MMVD) mode, an adaptive motion vector prediction (AMVP) mode with symmetric MVD signaling, an affine motion compensated prediction, a subblock-based temporal motion vector prediction (SbTMVP), an adaptive motion vector resolution (AMVR), a motion field storage ( 1/16th luma sample MV storage and 8×8 motion field compression), a bi-prediction with CU-level weights (BCW), a bi-directional optical flow (BDOF), a prediction refinement using optical flow (PROF), a decoder side motion vector refinement (DMVR), a combined inter and intra prediction (CIIP), a geometric partitioning mode (GPM), and the like. Inter predictions and related methods are described in details below.

Extended merge prediction can be used in some examples. In an example, such as in VTM4, a merge candidate list is constructed by including the following five types of candidates in order: spatial motion vector predictor(s) (MVP(s)) from spatial neighboring CU(s), temporal MVP(s) from collocated CU(s), history-based MVP(s) from a first-in-first-out (FIFO) table, pairwise average MVP(s), and zero MV(s).

A size of the merge candidate list can be signaled in a slice header. In an example, the maximum allowed size of the merge candidate list is 6 in VTM4. For each CU coded in the merge mode, an index (e.g., a merge index) of a best merge candidate can be encoded using truncated unary binarization (TU). The first bin of the merge index can be coded with context coding (e.g., context-adaptive binary arithmetic coding (CABAC)) and a bypass coding can be used for other bins.

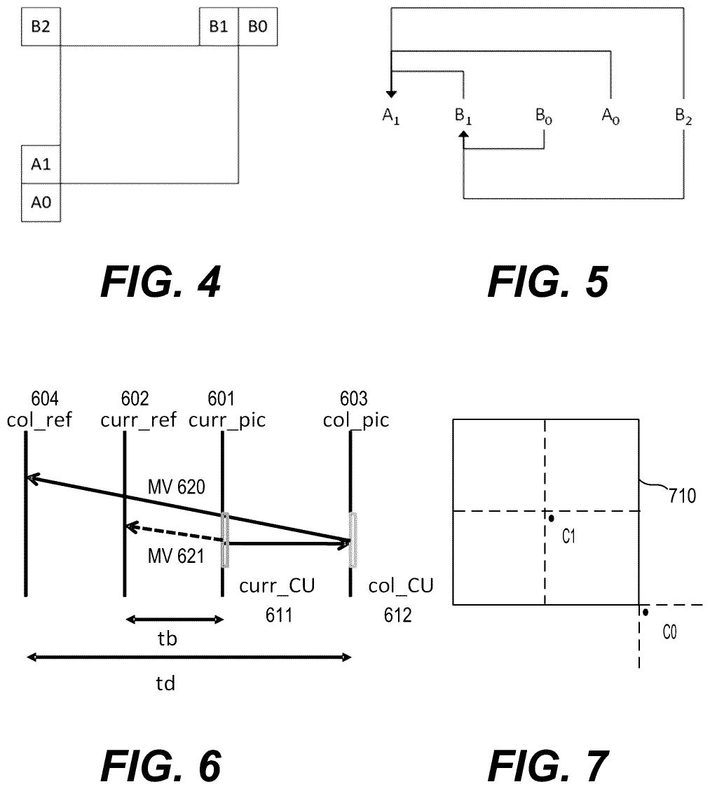

Some examples of a generation process of each category of merge candidates are provided below. In an aspect, spatial candidate(s) are derived as follows. The derivation of spatial merge candidates in VVC can be identical to that in HEVC. In an example, a maximum of four merge candidates are selected among candidates located in positions depicted in FIG. 4. FIG. 4 shows positions of spatial merge candidates according to an aspect of the disclosure. Referring to FIG. 4, an order of derivation is B1, A1, B0, A0, and B2. The position B2 is considered only when any CU of positions A0, B0, B1, and A1 is not available (e.g., because the CU belongs to another slice or another tile) or is intra coded. After a candidate at the position A1 is added, the addition of the remaining candidates is subject to a redundancy check which ensures that candidates with the same motion information are excluded from the candidate list so that coding efficiency is improved.

To reduce computational complexity, not all possible candidate pairs are considered in the mentioned redundancy check. Instead, only pairs linked with an arrow in FIG. 5 are considered and a candidate is only added to the candidate list if the corresponding candidate used for the redundancy check does not have the same motion information. FIG. 5 shows candidate pairs that are considered for a redundancy check of spatial merge candidates according to an aspect of the disclosure. Referring to FIG. 5, the pairs linked with respective arrows include A1 and B1, A1 and A0, A1 and B2, B1 and B0, and B1 and B2. Thus, candidates at the positions B1, A0, and/or B2 can be compared with the candidate at the position A1, and candidates at the positions B0 and/or B2 can be compared with the candidate at the position B1.

In an aspect, temporal candidate(s) are derived as follows. In an example, only one temporal merge candidate is added to the candidate list. FIG. 6 shows exemplary motion vector scaling for a temporal merge candidate. To derive the temporal merge candidate of a current CU (611) in a current picture (601), a scaled MV (621) (e.g., shown by a dotted line in FIG. 6) can be derived based on a co-located CU (612) in a collocated picture (603). A reference picture list used to derive the co-located CU (612) can be explicitly signaled in a slice header. The scaled MV (621) for the temporal merge candidate can be obtained as shown by the dotted line in FIG. 6. The scaled MV (621) can be scaled from the MV (620) of the co-located CU (612) using picture order count (POC) distances tb and td. The POC distance tb can be defined to be the POC difference between a current reference picture (602) of the current picture (601) and the current picture (601). The POC distance td can be defined to be the POC difference between the co-located reference picture (604) of the co-located picture (603) and the co-located picture (603). A reference picture index of the temporal merge candidate can be set to zero.

FIG. 7 shows examples of candidate positions (e.g., C0 and C1) for a temporal merge candidate of a current CU. A position for the temporal merge candidate can be selected between the candidate positions C0 and C1. The candidate position C0 is located at a bottom-right corner of a co-located CU (710) of the current CU. The candidate position C1 is located at a center of the co-located CU (710) of the current CU (710). If a CU at the candidate position C0 is not available, is intra coded, or is outside of a current row of CTUs, the candidate position C1 is used to derive the temporal merge candidate. Otherwise, for example, the CU at the candidate position C0 is available, not intra coded, and in the current row of CTUs, the candidate position C0 is used to derive the temporal merge candidate.

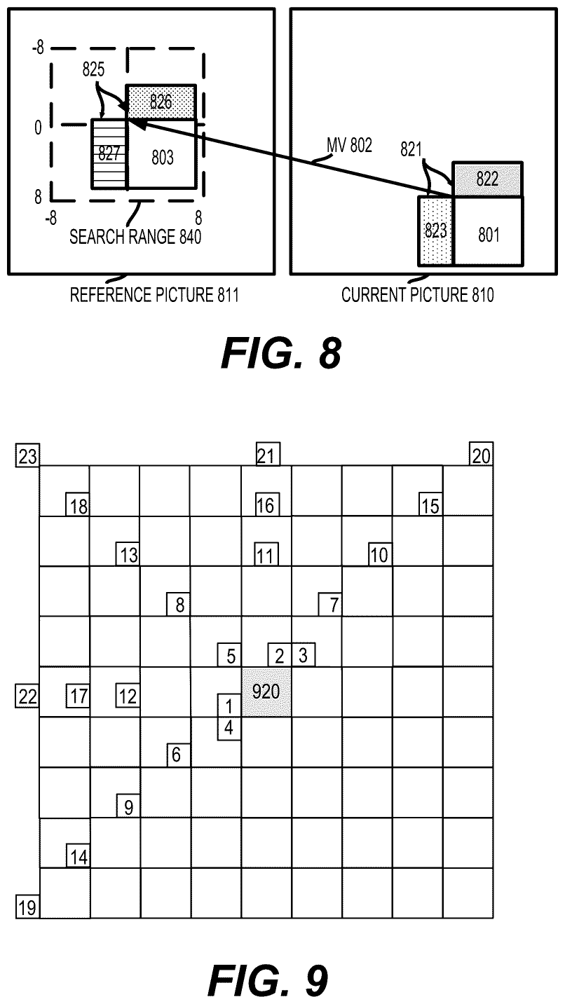

In an aspect, template matching (TM) or a TM mode may be used to refine motion or motion information at the decoder side. FIG. 8 shows an example of the TM mode according to an aspect of the disclosure. In the TM mode, the motion information may be refined by constructing a template from the left and the above neighboring reconstructed samples of a current block (801) and finding the closest match between the template (e.g., a current template) (821) in a current picture (810) and a template (e.g., a reference template) (825) in the reference frame (also referred to as a reference picture) (811).

Referring to FIG. 8, a better MV is to be searched around an initial motion (e.g., motion information including an MV) (802) of the current CU (801) within a search range (840) such as a [−8, +8]-pel search range. In some examples, the template matching may be applied with modifications. In an example, a search step size is determined by the AMVR mode. In an example, the TM can be cascaded with a bilateral matching process.

In an example, the current template (821) includes a top template (822) above the current block (801) and/or a left template (823) to the left of the current block (801). In an example, the reference template (825) includes a top template (826) above a reference block (803) in the reference picture (811) and/or a left template (827) to the left of the reference block (803).

Non-adjacent spatial merge candidate(s) may be used in video coding. FIG. 9 shows an example of a pattern of non-adjacent spatial merge candidates, such as non-adjacent spatial merge candidates 1-23, according to an aspect of the disclosure. The non-adjacent spatial merge candidates may be inserted in a regular merge candidate list, for example, after a temporal motion vector predictor (TMVP) in the regular merge candidate list. Distances between the non-adjacent spatial merge candidates 1-23 and a current coding block (920) may be based on a width and a height of the current coding block (920).

Adaptive reordering of merge candidate with template matching may be used. In some examples, such as in ECM, the regular merge, TM merge, and BM merge candidates are construed by using the following types of candidate lists in order of: spatial MVP (SMVP) from spatial neighbor CUs, TMVP from collocated CUs, non-adjacent MVP (NA-MVP) from spatially non-adjacent CUs, history-based MVP (HMVP) from a FIFO table, pairwise average MVP (PAMVP), and zero MV(s).

An adaptive reordering of merge candidates with template matching (ARMC) method may be used to reorder the MV candidates for each candidate list based on the TM cost. The candidate list, which may include candidate type(s) such as a TMVP type or an NA-SMVP type, may be reordered by using the TM cost, for example, in an ascending order. The reordering method may be applied to different types of merge modes such as the regular merge mode, the template matching (TM) merge mode, and the affine merge mode (excluding the SbTMVP candidate). For the TM merge mode, merge candidates may be reordered before the refinement process. After a merge candidate list is constructed, merge candidates may be divided into several subgroups. The subgroup size may be set to, for example, 5. Merge candidates in each subgroup may be reordered in the ascending order according to the TM costs (or cost values) based on the template matching. In an example, to simplify the process, if the last subgroup is not the first subgroup, merge candidates in the last subgroup are not reordered. For subblock-based merge candidates with a subblock size equal to Wsub×Hsub, the above template (also referred to as the top template) may include several sub-templates with a size of Wsub×1, and the left template may include several sub-templates with a size of 1×Hsub.

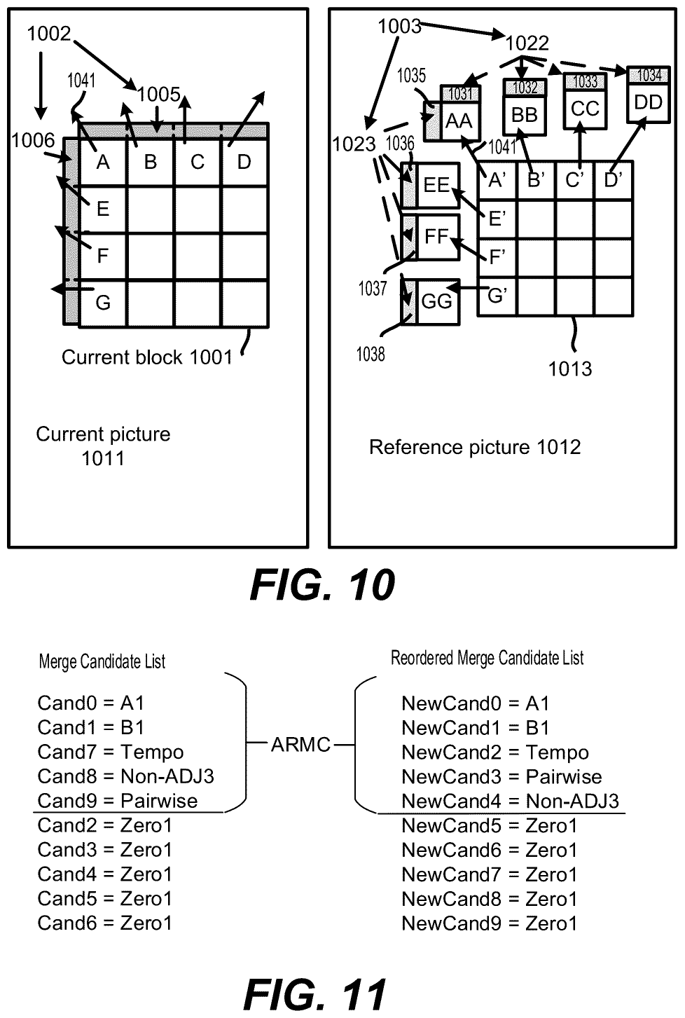

FIG. 10 shows examples of a template (1002) and a reference template (1003) including reference samples of the template (1002) for a block (or a current block) (1001) with sub-block motion using the motion information of the subblocks of the current block (1001) according to an aspect of the disclosure.

Referring to FIG. 10, the current block (1001) in a current picture (1011) includes subblocks, and the subblocks in the current block (1001) may be predicted with motion information (e.g., subblock motion information) of the respective subblocks. The template (1002) (e.g., the current template (1002) may include an above template (1005) that is above the current block (1001) and a left template (1006) to the left of the current block (1001).

In an example, the motion information of the subblocks A-G in the first row and the first column of the current block (1001) is used to derive the reference samples of each sub-template of the current template (1002). The current block (1001) may be collocated with a collocated block (1013) in a reference picture (1012) of the current picture (1011). Subblocks A′-G′ in the collocated block (1013) correspond to the subblocks A-G in the current block (1001). Subblocks AA-GG in the reference picture (1012) may be determined based on the subblocks A′-G′, respectively. For example, the subblock AA is determined based on the subblock motion information (1041) of the subblock A. A reference top template (1022) may include reference sub-templates (1031)-(1034) that are above the subblocks AA-DD, respectively. A reference left template (1023) may include reference sub-templates (1035)-(1038) that are to the left of the subblocks AA, EE, FF, and GG, respectively. In an example, the reference template (1003) includes the reference top template (1022) and the reference left template (1023).

In some examples, to improve coding efficiency, the MV candidates reordering may be applied to the single TMVP type, the single non-adjacent MVP (NA-MVP) type, and hybrid candidate types including the NA-MVP type, the HMVP type, the PAMVP types, and the like. In an example, the merge candidate list includes duplicate zero MV candidates. The duplicate zero MV candidates, which for example indicate that the MV is (0, 0) for all available candidates in the reference list, may be sorted at the early position. In some examples, Zero MV candidates (e.g., all Zero MV candidates) are excluded from the ARMC reordering process. After the ARMC reordering, the duplicate Zero MVs may be filled at the end of the merge list, as shown in FIG. 11.

FIG. 11 shows an example of zero candidates exclusion in the ARMC process according to an aspect of the disclosure. The merge candidate list includes candidates Cand0 to Cand9, and Cand2 to Cand6 are the zero MVs. When the ARMC reordering process is applied, the zero MVs Cand2 to Cand6 are excluded, and thus only Cand0, Cand1, and Cand7 to Cand9 are reordered. In the reordered merge candidate list, Cand0, Cand1, and Cand7 to Cand9 are reordered as NewCand0 to NewCand4 as shown in FIG. 11. In an example, Cand7 becomes NewCand2, Cand9 becomes NewCand3, and Cand8 becomes NewCand4. Further, after the ARMC reordering, the duplicate Zero MVs Cand2 to Cand6 may be filled at the end of the reordered merge list as NewCand5 to NewCand9.

In an aspect, an intra block copy (IBC) mode is a tool adopted in HEVC extensions on screen content coding (SCC). The IBC mode may significantly improve the coding efficiency of screen content materials. Since the IBC mode may be implemented as a block level coding mode, block matching (BM) may be performed at the encoder to find an optimal block vector (BV) (or MV) for each CU. The BV may be used to indicate a displacement from a current block in a current picture to a reference block. The reference block may be already reconstructed inside the current picture. A luma BV of an IBC-coded CU may be in an integer precision. A chroma BV may round to the integer precision as well. When combined with the AMVR mode, the IBC mode may switch between 1-pel and 4-pel motion vector precisions. An IBC-coded CU may be treated as a third prediction mode other than the intra prediction mode or the inter prediction mode. The IBC mode may be applicable to CUs with both a width and a height smaller than or equal to 64 luma samples.

At the encoder side, hash-based motion estimation may be performed for the IBC mode. The encoder may perform a rate-distortion (RD) check for blocks with either width or height no larger than 16 luma samples. For a non-merge mode, the BV search may be performed using hash-based search first. If the hash-based search does not return a valid candidate, a block matching based local search may be performed.

In the hash-based search, hash key matching (32-bit cyclic redundancy check (CRC)) between a current block and a reference block may be extended to all allowed block sizes. The hash key calculation for every position in the current picture may be based on 4×4 subblocks. For the current block of a larger size, a hash key may be determined to match that of the reference block when all the hash keys of the respective 4×4 subblocks match the hash keys in the corresponding reference locations. If hash keys of multiple reference blocks are found to match those of the current block, the BV costs of each matched reference may be calculated and the one with the minimum cost is selected.

In the block matching search, the search range may be set to include both the previous CTU and the current CTU.

At a CU level, the IBC mode may be signalled with a flag and may be signaled as an IBC AMVP mode or an IBC skip/merge mode as follows:
The IBC skip/merge mode: a merge candidate index is used to indicate which of the BVs in the merge list from neighboring candidate IBC coded blocks is used to predict the current block. The merge list may include or consist of spatial, HMVP, and pairwise candidates.
The IBC AMVP mode: a BV difference is coded in the same way as an MV difference. The BV prediction method may use two candidates as predictors (e.g., BV predictors), one from a left neighbor (if the left neighbor is IBC coded) and one from an above neighbor (if the top neighbor is IBC coded). When either neighbor is not available, a default BV may be used as a predictor (e.g., a BV predictor). A flag is signaled to indicate the BV predictor index.

A reconstruction-reordered IBC (RR-IBC) mode may be used. The RR-IBC mode may be allowed for IBC coded blocks, for example, in ECM. When RR-IBC mode is applied, samples in a reconstruction block may be flipped according to a flip type of the current block. At the encoder side, the original block may be flipped before motion search and residual calculation, and the prediction block is derived without flipping. At the decoder side, the reconstruction block may be flipped back to restore the original block.

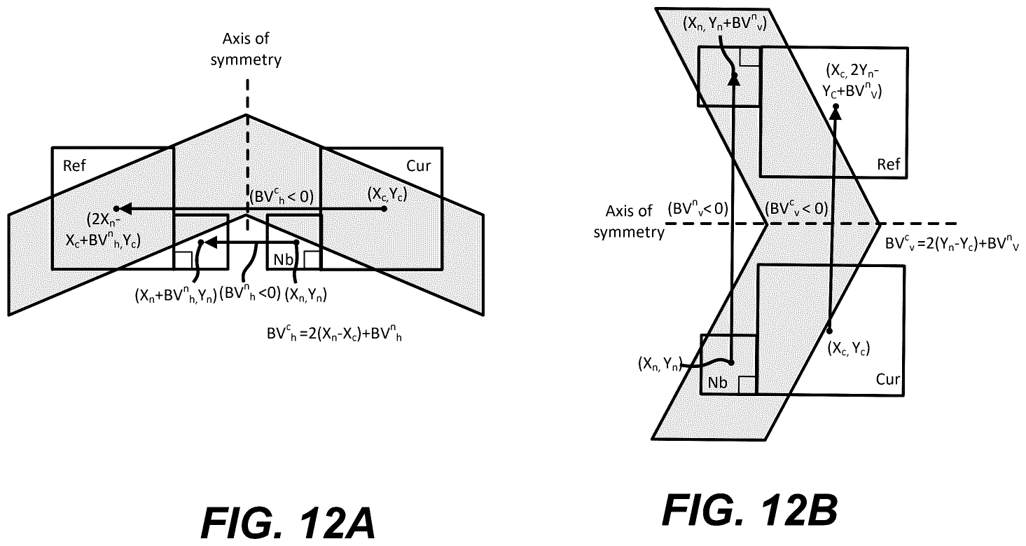

To better utilize the symmetry property, a flip-aware BV adjustment approach may be applied to refine the BV candidate. FIG. 12A shows an example of the BV adjustment for a horizontal flip according to an aspect of the disclosure. FIG. 12B shows an example of the BV adjustment for a vertical flip according to an aspect of the disclosure.

Referring to FIGS. 12A-12B, (x_{nbr}, y_{nbr}) (referred to as (xₙ, yₙ) in FIGS. 12A-12B) and (x_{cur}, y_{cur}) (referred to as (x_{c}, y_{c}) in FIGS. 12A-12B) represent coordinates of a center sample of a neighboring block (Nb) and a current block (Cur), respectively. BV^{nbr} and BV^{cur} denote a BV of the neighboring block and a BV of the current block, respectively. Instead of directly inheriting the BV from the neighboring block, a horizontal component (referred to as BV^{c}ₕ in FIG. 12A) of BV^{cur} may be calculated by adding a motion shift to a horizontal component (BV^{nbr}ₕ which is referred to as BVⁿₕ in FIG. 12A) of BV^{nbr} when the neighboring block is coded with the horizontal flip, e.g., BV^{cur}ₕ=2 (x_{nbr}−x_{cur})+BV^{nbr}ₕ which is BV^{c}ₕ=2 (xₙ−x_{c})+BVⁿₕ as shown in FIG. 12A.

Similarly, referring to FIG. 12B, the vertical component (referred to as BV^{c}ᵥ in FIG. 12B) of BV^{cur} may be calculated by adding a motion shift to the vertical component (BV^{nbr}ᵥ which is referred to as BVⁿᵥ in FIG. 12B) of BV^{nbr} when the neighboring block is coded with the vertical flip, e.g., BV^{cur}ᵥ=2 (y_{nbr}−y_{cur})+BV^{nbr}ᵥ which is BV^{c}ᵥ=2 (yₙ−y_{c})+BVⁿᵥ as shown in FIG. 12B.

Multiple Transform Selection (MTS) may be used in some examples. In addition to DCT-II which has been employed in HEVC, the MTS scheme may be used for residual coding inter coded blocks and intra coded blocks. The MTS scheme may use multiple selected transforms from suitable transforms matrices such as DCT8 (DCT-VIII), DST7 (DST-VII), DCT5, DST4, DST1, identity transform (IDT), and/or the like. Table 1 shows examples of basis functions of the selected DST/DCT.

TABLE 1
Transform basis functions of DCT-II, DCT-VIII, and
DST-VII for N-point input

| Transform Type | Basis function Tᵢ(j), i, j = 0, 1, . .. , N − 1 |
|---|---|
| DCT-II | ${T}_{i} ( j ) = {ω}_{0} \cdot \sqrt{\frac{2}{N}} \cdot cos ( \frac{π \cdot i \cdot ( 2 j + 1 )}{2 N} )$ |
| | $where , {ω}_{0} = \{ \begin{matrix}\sqrt{\frac{2}{N}} & i = 0 \\ 1 & i \neq 0\end{matrix}$ |
| DCT-VIII | ${T}_{i} ( j ) = \sqrt{\frac{4}{2 N + 1}} \cdot cos ( \frac{π \cdot ( 2 i + 1 ) \cdot ( 2 j + 1 )}{4 N + 2} )$ |
| DSTVII | ${T}_{i} ( j ) = \sqrt{\frac{4}{2 N + 1}} \cdot sin ( \frac{π \cdot ( 2 i + 1 ) \cdot ( j + 1 )}{2 N + 1} )$ |

In an example, to keep the orthogonality of the transform matrix, the transform matrices may be quantized more accurately than the transform matrices in HEVC. In some examples, to keep intermediate values of the transformed coefficients within a 16-bit range, after a horizontal transform and after a vertical transform, the coefficients (e.g., all the coefficients) are to have 10 bits.

In an example, to control the MTS scheme, separate enabling flags may be specified at a sequence parameter set (SPS) level for inter coded blocks and intra coded blocks, respectively. When the MTS is enabled at the SPS, a CU level flag may be signaled to indicate whether the MTS is applied or not. In an example, the MTS is applied only to a luma component, such as a luma TB. The MTS signaling may be skipped when one of the below conditions is applied.
The position of the last significant coefficient for the luma TB is less than 1 (e.g., DC only).
The last significant coefficient of the luma TB is located inside the MTS zero-out region.

In an example, if the MTS CU flag is equal to zero, then DCT2 is applied in both directions, e.g., the horizontal and vertical directions. If the MTS CU flag is equal to one, then two additional flags may be signaled to indicate the transform type for the horizontal and vertical directions, respectively. Table 2 shows a mapping between flags and the corresponding transforms. Unified transform selection for the Intra Sub-partitions (ISP) mode and the implicit MTS may be used by removing the intra-mode and block-shape dependencies. If a current block is coded using the ISP mode or if the current block is an intra block and both intra and inter explicit MTS is on, then only DST7 is used for both horizontal and vertical transform cores. Regarding a transform matrix precision, 8-bit primary transform cores may be used in some examples. In some examples, the transform cores such as all the transform cores used in HEVC, are kept as the same, including 4-point DCT-2 and DST-7, 8-point, 16-point and 32-point DCT-2. Other transform cores including 64-point DCT-2, 4-point DCT-8, 8-point, 16-point, 32-point DST-7 and DCT-8, may be use 8-bit primary transform cores.

TABLE 2
Transform and signaling mapping

| | | | Intra/inter | |
|---|---|---|---|---|
| MTS_CU_flag | MTS_Hor_flag | MTS_Ver_flag | Horizontal | Vertical |
| 0 | | | DCT2 | |
| 1 | 0 | 0 | DST7 | DST7 |
| | 0 | 1 | DCT8 | DST7 |
| | 1 | 0 | DST7 | DCT8 |
| | 1 | 1 | DCT8 | DCT8 |

To reduce the complexity of a large size DST-7 and DCT-8, high frequency transform coefficients may be zeroed out for the DST-7 and DCT-8 blocks with size (width or height, or both width and height) equal to 32. In an example, only the coefficients within the 16×16 lower-frequency region are retained.

As in HEVC, in some examples, the residual of a block can be coded with a transform skip mode. To avoid the redundancy of syntax coding, in an example, the transform skip flag is not signalled when the CU level MTS_CU_flag is not equal to zero. Implicit MTS transform may be set to DCT2 when a low-frequency non-separable transform (LFNST) or Matrix-Weighted Intra Prediction (MIP) is activated for the current CU. The implicit MTS may be enabled when the MTS is enabled for inter coded blocks.

A transform, such as a primary transform, a secondary transform, can be applied to a block. In an example, a transform includes a combination of a primary transform and a secondary transform. In an example, a transform includes a non-separable transform. In an example, a transform includes a separable transform. A primary transform may be referred to as a forward primary transform at the encoder side, and may be referred to as an inverse primary transform at the decoder side. A secondary transform may be referred to as a forward secondary transform at the encoder side, and may be referred to as an inverse secondary transform at the decoder side.

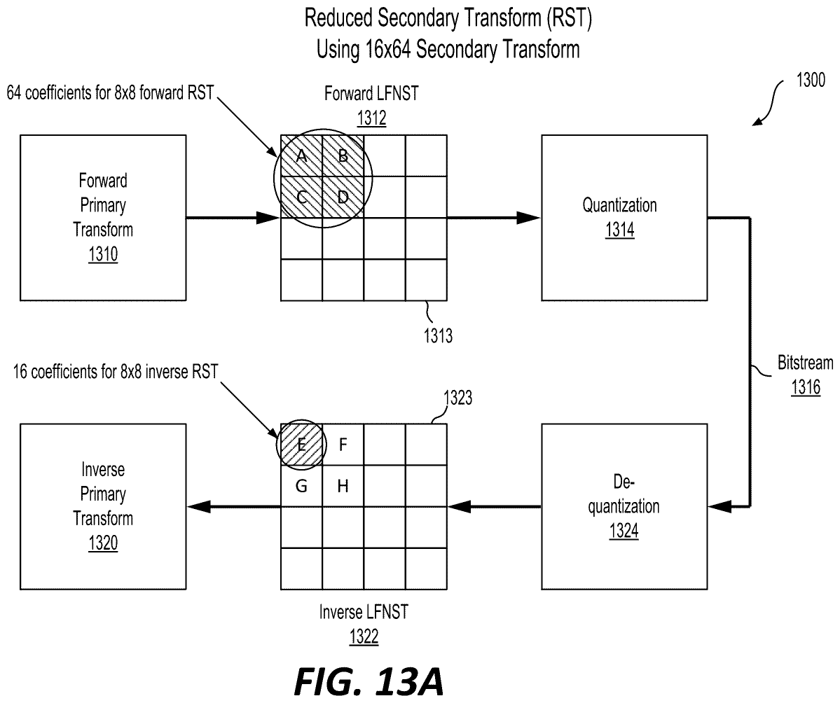

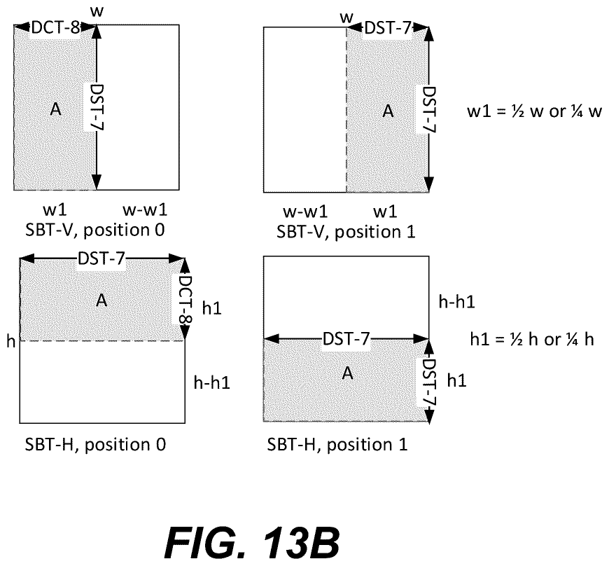

A secondary transform can be performed such as in VVC. In some examples, such as in VVC, a secondary transform such as a low-frequency non-separable transform (LFNST) can be applied between a forward primary transform and quantization at an encoder side and between de-quantization and an inverse primary transform at a decoder side as shown in FIG. 13A. A reduced secondary transform (RST) method can be used in the LFNST.

Application of a non-separable transform, which can be used in an LFNST, can be described as follows using a 4×4 input block (or an input matrix) X as an example such as shown in Eq. (1). To apply the 4×4 non-separable transform (e.g., the LFNST), the 4×4 input block X can be represented by a vector [symbol] , as shown in Eqs. 1-2.

$$X = [ \begin{matrix}{X}_{00} & {X}_{01} & {X}_{02} & {X}_{03} \\ {X}_{10} & {X}_{11} & {X}_{12} & {X}_{13} \\ {X}_{20} & {X}_{12} & {X}_{22} & {X}_{23} \\ {X}_{30} & {X}_{13} & {X}_{32} & {X}_{33}\end{matrix} ] \qquad Eq . ( 1 )$$

$$\vec{X} = {[ \begin{matrix}{X}_{00} & {X}_{01} & {X}_{02} & {X}_{03} & {X}_{10} & {X}_{11} & {X}_{12} & {X}_{13} & {X}_{20} & {X}_{21} & {X}_{22} & {X}_{23} & {X}_{30} & {X}_{31} & {X}_{32} & {X}_{33}\end{matrix} ]}^{T} \qquad Eq . ( 2 )$$

The non-separable transform can be calculated as [symbol] =T· [symbol] , where [symbol] indicates a transform coefficient vector, and T is a 16×16 transform matrix. The 16×1 coefficient vector \vec{F} can be subsequently reorganized into a 4×4 output block (or an output matrix, a coefficient block) using a scanning order (e.g., a horizontal scanning order, a vertical scanning order, a zigzag scanning order, or a diagonal scanning order) for the 4×4 input block. The transform coefficients with smaller indices can be placed with smaller scanning indices in the 4×4 coefficient block.

FIG. 13A shows an example of a transform coding process (1300) using a 16×64 transform (or a 64×16 transform depending on whether the transform is a forward or inverse secondary transform). Referring to FIG. 13A, in the process (1300), at an encoder side, a forward primary transform (1310) can first be performed over a block (e.g., a residual block) to obtain a coefficient block (1313). Subsequently, a forward secondary transform (or a forward LFNST) (1312) can be applied to the coefficient block (1313). In the forward secondary transform (1312), 64 coefficients of 4×4 sub-blocks A-D at a top-left corner of the coefficient block (1313) can be represented by a 64-length vector, and the 64-length vector can be multiplied with a transform matrix of 64×16 (i.e., a width of 64 and a height of 16), resulting in a 16-length vector. Elements in the 16-length vector are filled back into the top-left 4×4 sub-block A of the coefficient block (1313). The coefficients in the sub-blocks B-D can be zero. The resulting coefficients after the forward secondary transform (1312) are then quantized at a quantization step (1314), and entropy-coded to generate coded bits in a bitstream (1316).

The coded bits can be received at a decoder side, and entropy-decoded followed by a de-quantization step (1324) to generate a coefficient block (1323). An inverse secondary transform (or an inverse LFNST) (1322), such as an inverse RST8×8, can be performed to obtain 64 coefficients, for example, from the 16 coefficients at a top-left 4×4 sub-block E. The 64 coefficients can be filled back to the 4×4 sub-blocks E-H. Further, the coefficients in the coefficient block (1323) after the inverse secondary transform (1322) can be processed with an inverse primary transform (1320) to obtain a recovered residual block.

In an example, a 4×4 non-separable transform (e.g., a 4×4 LFNST) or an 8×8 non-separable transform (e.g., an 8×8 LFNST) is applied according to a block size of the block. The block size of the block can include a width, a height, or the like. For example, the 4×4 LFNST is applied for the block where a minimum of the width and the height is less than a threshold, such as 8 (e.g., min (the width, the height)<8). For example, the 8×8 LFNST is applied for the block where the minimum of the width and the height is larger than a threshold, such as 4 (e.g., min (width, height)>4).

A non-separable transform (e.g., the LFNST) can be based on a direct matrix multiplication approach, and thus can be implemented in a single pass without iteration. To reduce a non-separable transform matrix dimension and to minimize computational complexity and memory space to store transform coefficients, a reduced non-separable transform method (or RST) can be used in the LFNST. Accordingly, in the reduced non-separable transform, an N (e.g., N is 64 for an 8×8 non-separable secondary transform (NSST)) dimensional vector can be mapped to an R dimensional vector in a different space, where N/R (R<N) is a reduction factor. Hence, instead of an N×N matrix, an RST matrix is an R×N matrix as described in Eq. (3).

$${T}_{R \times N} = [ \begin{matrix}{t}_{11} & {t}_{12} & {t}_{13} & … & {t}_{1 N} \\ {t}_{21} & {t}_{22} & {t}_{23} & & {t}_{2 N} \\ & ⋮ & & ⋱ & ⋮ \\ {t}_{R 1} & {t}_{R 2} & {t}_{R 3} & ⋯ & {t}_{RN}\end{matrix} ] \qquad Eq . ( 3 )$$

In Eq. (3), R rows of the R×N transform matrix are R bases of the N dimensional space. The inverse transform matrix can be a transpose of the transform matrix (e.g., TR×N) used in the forward transform. For an 8×8 LFNST, a reduction factor of 4 can be applied, and a 64×64 direct matrix used in an 8×8 non-separable transform can be reduced to a 16×64 direct matrix, as shown in FIG. 13A. Alternatively, a reduction factor larger than 4 can be applied, and the 64×64 direct matrix used in the 8×8 non-separable transform can be reduced to a 16×48 direct matrix. Hence, a 48×16 inverse RST matrix can be used at a decoder side to generate core (primary) transform coefficients in an 8×8 top-left region.

When the 16×48 matrix is applied instead of the 16×64 matrix with a same transform set configuration, an input to the 16×48 matrix includes 48 input data from three 4×4 blocks A, B, and C in a top-left 8×8 block excluding a right-bottom 4×4 block D. With a reduction in the dimension, a memory usage for storing LFNST matrices can be reduced, for example, from 10 KB to 8 KB with a minimal performance drop.

In order to reduce complexity, the LFNST can be restricted to be applicable if coefficients outside a first coefficient subgroup are non-significant. In an example, the LFNST can be restricted to be applicable only if all coefficients outside the first coefficient subgroup are not significant. Referring to FIG. 13A, the first coefficient subgroup corresponds to the top-left block E, and thus the coefficients that are outside the block E are not significant.

Subblock transform (SBT) may be used. In some examples, such as in VTM, the subblock transform is used for an inter-predicted CU. In the subblock transform mode, for example, only a sub-part of a residual block is coded for the CU. When an inter-predicted CU with cu_cbf equal to 1, a flag (e.g., cu_sbt_flag) may be signaled to indicate whether the whole residual block or the sub-part of the residual block is coded. In the former case (the whole residual block is coded), inter MTS information may be further parsed to determine the transform type of the CU. In the latter case (the sub-part of the residual block is coded), a part of the residual block is coded with inferred adaptive transform and the other part of the residual block is zeroed out.

When the SBT is used for an inter-coded CU, an SBT type and an SBT position information may be signaled in a bitstream. Two SBT types (e.g., SBT-V and SBT-H)) and two SBT positions (e.g., positions 0-1) may be applied. FIG. 13B shows examples of the SBT positions, the SBT types, and respective transform types according to an aspect of the disclosure. For SBT-V (or SBT-H), a TU width (or a TU height) may equal to half of the CU width (or the CU height), resulting in a 2:2 split. For SBT-V (or SBT-H), a TU width (or a TU height) may equal to ¼ of the CU width (or the CU height), resulting in a 1:3 or a 3:1 split. The 2:2 split may be similar to a binary tree (BT) split, and the 1:3 split or the 3:1 split may be similar to an asymmetric binary tree (ABT) split. In the ABT splitting, for example, only the small region includes the non-zero residual. In an example, if a dimension of a CU is 8 in luma samples, the 1:3 split or the 3:1 split along the dimension may be disallowed. In an example, there are at most 8 SBT modes for a CU.

Position-dependent transform core selection may be applied on luma transform blocks in the SBT-V type and the SBT-H type. In an example, DCT-2 is used for chroma blocks, such as a chroma TB. The two positions of SBT-H and SBT-V may be associated with different core transforms. In an aspect, the horizontal and vertical transforms for each SBT position may be specified, such as shown in FIG. 13B. For example, the horizontal and vertical transforms for the SBT-V position 0 may be DCT-8 and DST-7, respectively. When one side of the residual TU is greater than 32, the transform for both dimensions may be set as DCT-2. Thus, in an example, the subblock transform jointly specifies the TU tiling, a coded block flag (cbf), and horizontal and vertical core transform types of a residual block.

In an example, the SBT is not applied to the CU coded with the combined inter-intra mode.

In some examples, multiple transform kernels, such as DCT2, DCT8, DST7 and the like, are supported for a coded block coded by the inter prediction mode or the IBC mode, however, transform types are not inherited for the merge candidate list construction.

Aspects of the disclosure provide techniques, apparatuses, and methods related to inheriting or including transform type information in a merge candidate list, such as inherited transform type(s) in a merge mode with multiple transform type selection.

The methods, aspects, and examples described in the disclosure may be used separately or combined in any order. The methods, aspects, and examples may be implemented by processing circuitry (e.g., one or more processors or one or more integrated circuits). In one example, the one or more processors execute a program that is stored in a non-transitory computer-readable medium.

The term “merge mode” may refer to any suitable type of merge mode, for example, used in a hybrid video compression scheme. The merge mode may refer to a prediction mode where a merge candidate list is used to determine an MV or a BV of a current block to be coded or processed. Types of merge mode may include but are not limited to the regular merge mode used in inter prediction or a variant, the regular skip mode used in inter prediction or a variant, the IBC merge mode or a variant, the IBC skip mode or a variant, the IntraTMP mode or a variant, the affine merge mode or a variant, or the like. In an aspect, when a current block is coded with the merge mode, the merge candidate list may be constructed. In an example, the merge candidate list may be a merge candidate list in the regular merge mode in inter prediction, for example, to determine MV(s) for the current block. In an example, the merge candidate list may be a merge candidate list in other types of merge modes, such as the IBC merge mode, the IBC skip mode, the IntraTMP mode, for example, to determine a BV for the current block.

Transform type information of a merge candidate may include or indicate transform type(s) associated with the merge candidate in the merge candidate list of the current block. The transform type(s) may include primary transform types, a secondary transform type, and/or the like. The primary transform types may include one or more transform types used in the horizontal transform and the vertical transform, respectively, such as shown in Tables 1-2.

When the current block is coded using the merge mode such as any of the types of merge modes described above, the merge candidate list of the current block may be constructed. The transform type information of the merge candidate may be added into the merge candidate list of the current block. Thus, in addition to inheriting one of motion information (e.g., indicating or including MV information) and BV information in the merge candidate list, the transform type information may be inherited by the current block. An MV or a BV of the current block may be determined based on the inherited one of the motion information and the BV information. A transform according to the inherited transform type information may be performed on the current block to encode or decode the current block.

In an example, the merge candidate may include the transform type information and the one of the motion information and the BV information. When the merge candidate list is being constructed, the merge candidate may be added into the merge candidate list. The merge candidate including the transform type information and the one of the motion information and the BV information may be from any suitable candidate, such as described above. The merge candidate may be from a spatial neighbor of the current block, a temporal neighbor of the current block, a non-adjacent spatial merge candidate such as shown in FIG. 9, a history-based candidate (e.g., an HMVP or an HBVP), a pairwise candidate (e.g., a pairwise MVP), and the like.

In an aspect, the transform type information (e.g., including or indicating the transform type) may be inherited for the merge candidate list construction. In an example, the merge candidate list may be constructed such that the merge candidate includes the transform type used by the merge candidate.

In an example, when the transform type information is to be inherited by the current block, the transform type information of the merge candidate and the one of the motion information and the BV information of the merge candidate may be added into the merge candidate list of the current block. The current block may be coded (e.g., encoded or reconstructed) based on the merge candidate list. The merge candidate list may include the transform type information of the merge candidate and the one of the motion information and BV information of the merge candidate. In an example, the transform type information of the merge candidate is included in the merge candidate list when multiple transform selection (MTS) is available to the current block.

In an aspect, the transform type may be inherited when the current block (also referred to as the coded block) is coded in a merge mode such as any of the types of merge modes described above and the MTS is available. Thus, the merge candidate including the transform type information (e.g., including or indicating the transform type) may be added to the merge candidate list when the current block is coded in the merge mode and the MTS is available to the current block. In an example, whether the MTS is available is indicated by a flag, e.g., MTS_CU_flag, such as shown in Table 2. In an example, when the flag is 1, the MTS is available. In an example, the merge candidate including the transform type information (e.g., including or indicating the transform type) is selected to code the current block, and the current block may be transformed using the same transform type indicated by the transform type information. As described above, in an example, the transform type includes a horizontal transform type and a vertical transform type in a primary transform. In an example, the transform type includes a secondary transform of the current block.

In an example, the merge mode is the inter merge mode (e.g., the regular merge mode used in inter prediction), the motion information of the merge candidate indicates an MV and a reference picture, and the reference picture is different from a current picture of the current block. The current block may be coded based on the MV and the reference picture.

In an aspect, the merge mode used to code the current block is the IBC merge mode. A transform type of a neighbor block coded by the IntraTMP mode may be inherited by the current block (e.g., the coded block). The neighbor block coded by the IntraTMP mode may be referred to as the neighboring IntraTMP block, and may be a neighboring block of the current block. A BV of the IBC merge mode for the current block may be derived from the neighboring IntraTMP block.

In an example, the merge mode used to code the current block is the IBC merge mode. The merge candidate may be obtained from the neighboring IntraTMP block of the current block where the neighboring IntraTMP block is coded by the IntraTMP mode. The transform type information may include the transform type of the neighboring IntraTMP block. The one of the motion information and the BV information includes the BV of the neighboring IntraTMP block. Thus, the merge candidate may include the BV of the neighboring IntraTMP block and the transform type of the neighboring IntraTMP block.

In an aspect, the transform type information is to be inherited, for example, the transform type information of the merge candidate is included in the merge candidate list, when a block size (e.g., an area, a width, or a height) of the current block satisfies a predefined condition. The area, the width, or the height) of the current block may also be referred to as the block area, the block width, or the block height, respectively.

In an aspect, the inherited transform type is applied (e.g., the transform type information of the merge candidate is included in the merge candidate list) when the area (e.g., the block width and the block height) of the current block is larger than or equal to W₁×H₁. The W₁ and H₁ may be predefined values or may be signaled in a high-level syntax. The high-level syntax may include but is not limited to the SPS, a picture parameter set (PPS), a picture header (PH), a slice header, or the like.

In an aspect, the inherited transform type is applied when the area (e.g., the block width and the block height) of the current block is smaller than or equal to W₂×H₂. The W₂ and H₂ may be predefined values or may be signaled in a high-level syntax that may include but is not limited to the SPS, the PPS, the PH, the slice header, or the like.

In an aspect, the inherited transform type is applied when the block width is larger than or equal to W₃. The W₃ may be a predefined value or may be signaled in a high-level syntax that may include but is not limited to the SPS, the PPS, the PH, the slice header, or the like.

In an aspect, the inherited transform type is applied when the block height is larger than or equal to H₃. The H₃ may be a predefined value or may be signaled in a high-level syntax that may include but is not limited to the SPS, the PPS, the PH, the slice header, or the like.

In an aspect, the inherited transform type is applied when the block width is smaller than or equal to W₄. The W₄ may be a predefined value or may be signaled in a high-level syntax that may include but is not limited to the SPS, the PPS, the PH, the slice header, or the like.

In an aspect, the inherited transform type is applied when the block height is smaller than or equal to H₄. The H₄ may be a predefined value or may be signaled in a high-level syntax that may include but is not limited to the SPS, the PPS, the PH, the slice header, or the like.

In an aspect, a first syntax element (e.g., a flag) may be signaled in the bitstream to indicate whether the inheritance of transform type information (e.g., including or indicating transform type(s) from neighbor blocks) is applied or not to the current block (e.g., the coded block) when the MTS is used. In an example, the transform type information includes or indicates transform types from neighbor blocks, such as the transform type of the merge candidate described above. The first syntax element (e.g., the flag) may be signaled in any suitable part of the bitstream. For example, the flag may be signaled in different parts of the bitstream, including but not limited to the SPS, the PPS, the PH, the slice header, a coding unit (CU), a prediction unit (PU), a transform unit (TU), or the like. If the flag is true, the transform type information (e.g., the transform type of the neighbor block) may be inherited by the current block (e.g., the coded block). Otherwise, if the flag is false, a syntax (e.g., a second syntax element) of the transform type of the current block may be signaled in the bitstream and the selected transform type may be applied to the current block (e.g., the coded block).

In an example, the first syntax element indicating whether the transform type information is to be inherited by the current block may be included (e.g., signaled) in the bitstream. When the first syntax element indicates that the transform type information is not to be inherited by the current block, the bitstream (e.g., coded information in the bitstream) may include the second syntax element indicating the transform type of the current block. In an example, such as at the decoder side, the current block is reconstructed based on the transform type indicated by the second syntax element. In an example, the MTS is available to the current block.

In an example, when the inheritance of the transform type information is not applied to the current block, the merge candidate list of the current block may not include the transform type information, for example, the merge candidate in the merge candidate list may not include the transform type information. In another example, when the inheritance of the transform type information is not applied to the current block, the merge candidate in the merge candidate list of the current block may include the transform type information, and the current block may not inherit the transform type information when the one of the motion information and the BV information of the merge candidate is inherited by the current block.

In an aspect, the first syntax element (e.g., the flag) may be signaled to indicate whether the transform type is to be inherited or not when the current block (e.g., the coded block) is coded in the merge mode.

In an aspect, the first syntax element (e.g., the flag) may be signaled to indicate whether the transform type of the neighbor block (e.g., the neighboring IntraTMP block) coded by the IntraTMP mode is inherited by the current block (e.g., the coded block) or not when the BV of the IBC merge mode is derived from the neighboring IntraTMP block. In an example, the merge mode of the current block is the IBC merge mode, the merge candidate is from the neighboring IntraTMP block coded by the IntraTMP mode. The one of the motion information and the BV information in the merge candidate includes or indicates the BV of the neighboring IntraTMP block. When the BV of the IBC merge mode is derived from the BV of the neighboring IntraTMP block, the first syntax element (e.g., the flag) is signaled to indicate whether the transform type of the neighboring IntraTMP block is inherited by the current block. In an example, the transform type information includes the transform type of the neighboring IntraTMP block, the first syntax element (e.g., the flag) is signaled to indicate that the transform type of the neighboring IntraTMP block is inherited by the current block. Thus, a transform may be performed on the current block based on the transform type of the neighboring IntraTMP block.

In an aspect, the first syntax element (e.g., the flag) indicating whether the transform type information (e.g., including or indicating the transform type) is to be inherited by the current block may be signaled when one of (i) the block area, (ii) the block width, and (iii) the block height of the current block satisfies a predefined condition.

In an aspect, the flag is signaled to indicate whether the transform type is to be inherited or not when the block area is larger than or equal to Wₛ₁×Hₛ₁. The Wₛ₁ and Hₛ₁ may be predefined values or may be signaled in a high-level syntax that may include but is not limited to the SPS, the PPS, the PH, the slice header, or the like.

In an aspect, the flag is signaled to indicate whether the transform type is to be inherited or not when the block area is smaller than or equal to Wₛ₂×Hₛ₂. The Wₛ₂ and Hₛ₂ may be predefined values or may be signaled in a high-level syntax that may include but is not limited to the SPS, the PPS, the PH, the slice header, or the like.

In an aspect, the flag is signaled to indicate whether the transform type is to be inherited or not when the block width is larger than or equal to Wₛ₃. The Wₛ₃ may be a predefined value or may be signaled in a high-level syntax that may include but is not limited to the SPS, the PPS, the PH, the slice header, or the like.

In an aspect, the flag is signaled to indicate whether the transform type is to be inherited or not when the block width is smaller than or equal to Wₛ₄. The Wₛ₄ may be a predefined value or may be signaled in a high-level syntax that may include but is not limited to the SPS, the PPS, the PH, the slice header, or the like.

In an aspect, the flag is signaled to indicate whether the transform type is to be inherited or not when the block height is larger than or equal to Hₛ₃. The Hₛ₃ may be a predefined value or may be signaled in a high-level syntax that may include but is not limited to the SPS, the PPS, the PH, the slice header, or the like.

In an aspect, the flag is signaled to indicate whether the transform type is to be inherited or not when the block height is smaller than or equal to Hₛ₄. The Hₛ₄ may be a predefined value or may be signaled in a high-level syntax that may include but is not limited to the SPS, the PPS, the PH, the slice header, or the like.

The values W₁ to W₄, H₁ to H₄, Wₛ₁ to Wₛ₄, and Hₛ₁ to Hₛ₄ may be positive integers. The values W₁ to W₄, H₁ to H₄, Wₛ₁ to Wₛ₄, and Hₛ₁ to Hₛ₄ may be identical or different.

In an example, the merge candidate list includes the transform type information. Whether the current block uses the transform type information may depend on whether certain condition(s) are satisfied. In an example, when the certain condition(s) are not satisfied, the merge candidate list does not include the transform type information.

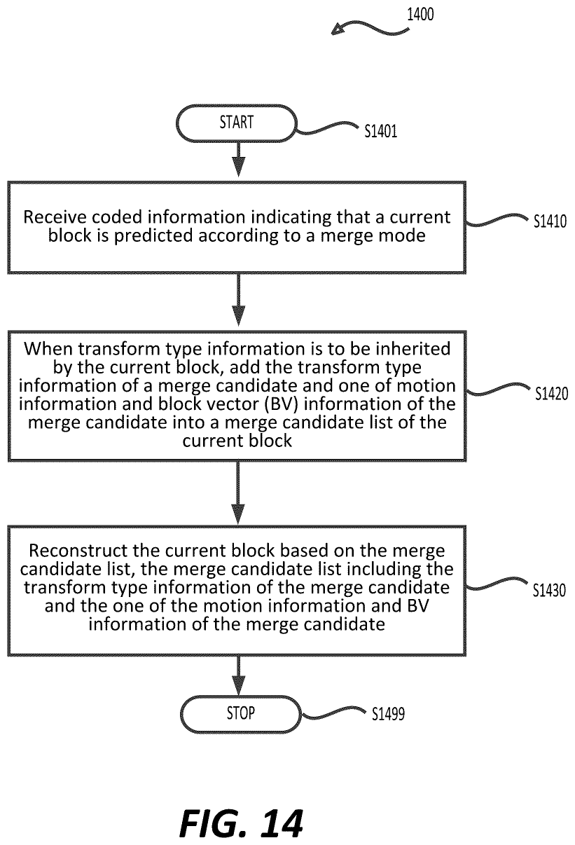

FIG. 14 shows a flow chart outlining a process (1400) according to an aspect of the disclosure. The process (1400) can be used in an apparatus, such as a video decoder. In various aspects, the process (1400) is executed by processing circuitry, such as the processing circuitry that performs functions of the video decoder (110), the processing circuitry that performs functions of the video decoder (210), and the like. In some aspects, the process (1400) is implemented in software instructions, thus when the processing circuitry executes the software instructions, the processing circuitry performs the process (1400). The process starts at (S1401) and proceeds to (S1410).

At (S1410), coded information indicating that a current block is predicted according to a merge mode is received. The merge mode may be any of the types of merge mode described above. In an example, the merge mode is one of an inter merge mode (e.g., the regular merge mode), the skip mode (e.g., the skip mode used in the inter prediction), the IBC merge mode, the IBC skip mode, the IntraTMP mode, and the affine merge mode.

At (S1420), when transform type information is to be inherited by the current block, the transform type information of a merge candidate and one of motion information and block vector (BV) information of the merge candidate is added into a merge candidate list of the current block.

At (S1430), the current block is reconstructed based on the merge candidate list, the merge candidate list including the transform type information of the merge candidate and the one of the motion information and BV information of the merge candidate.

Then, the process proceeds to (S1499) and terminates.

The process (1400) can be suitably adapted. Step(s) in the process (1400) can be modified and/or omitted. Additional step(s) can be added. Any suitable order of implementation can be used.

In an example, the transform type information of the merge candidate is included in the merge candidate list when the MTS is available to the current block.

In an example, the merge mode is an inter merge mode (e.g., the regular merge mode used in the inter prediction), the motion information of the merge candidate indicates an MV and a reference picture, and the reference picture is different from a current picture of the current block.

In an example, the merge mode is the IBC merge mode, and the merge candidate is from a neighboring IntraTMP block of the current block that is coded by the IntraTMP mode. The transform type information includes a transform type of the neighboring IntraTMP block, and the one of the motion information and the BV information includes a BV of the neighboring IntraTMP block.

In an example, the transform type information of the merge candidate is included in the merge candidate list when a block size of the current block satisfies a condition. The condition may be one of: (i) an area of the current block is larger than or equal to W₁×H₁ where W₁ and H₁ are predefined values or being signaled in a high level syntax, (ii) the area of the current block is smaller than or equal to W₂×H₂ where W₂ and H₂ are predefined values or being signaled in a high level syntax, (iii) a width of the current block is larger than or equal to W₃ that is a predefined value or is signaled in a high level syntax, (iv) the width of the current block is smaller than or equal to W₄ that is a predefined value or is signaled in a high level syntax, (v) a height of the current block is larger than or equal to H₃ that is a predefined value or is signaled in a high level syntax, and (vi) the height of the current block is smaller than or equal H₄ that is a predefined value or is signaled in a high level syntax.

In an example, the coded information includes a first syntax element (e.g., a flag) indicating whether the transform type information is to be inherited by the current block. When the first syntax element indicates that the transform type information is not to be inherited by the current block, the coded information includes a second syntax element indicating a transform type of the current block, and the current block is reconstructed based on the transform type indicated by the second syntax element.

In an example, the MTS is available to the current block.

In an example, the merge mode is the IBC merge mode, the merge candidate is from a neighboring IntraTMP block of the current block. The neighboring IntraTMP block is coded by the IntraTMP mode. The one of the motion information and the BV information includes a BV of the neighboring IntraTMP block, and the first syntax element indicates whether a transform type of the neighboring IntraTMP block is to be inherited by the current block.

In an example, the first syntax element indicating whether the transform type information is to be inherited by the current block is signaled when one of (i) an area, (ii) a width, and (iii) a height of the current block satisfies a condition such as a predefined condition.

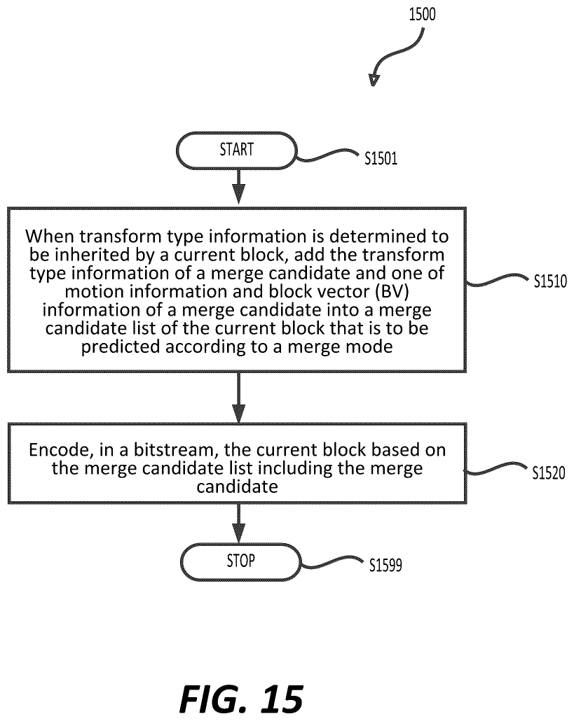

FIG. 15 shows a flow chart outlining a process (1900) according to an aspect of the disclosure. The process (1900) can be used in a video encoder. In various aspects, the process (1900) is executed by processing circuitry, such as the processing circuitry that performs functions of the video encoder (103), the processing circuitry that performs functions of the video encoder (303), and the like. In some aspects, the process (1900) is implemented in software instructions, thus when the processing circuitry executes the software instructions, the processing circuitry performs the process (1900). The process starts at (S1501) and proceeds to (S1510).

At (S1510), when transform type information is determined to be inherited by a current block, the transform type information of a merge candidate and one of motion information and block vector (BV) information of a merge candidate is added into a merge candidate list of the current block that is to be predicted according to a merge mode.

At (S1520), the current block is encoded in a bitstream based on the merge candidate list including the merge candidate.

Then, the process proceeds to (S1599) and terminates.

The process (1500) can be suitably adapted. Step(s) in the process (1500) can be modified and/or omitted. Additional step(s) can be added. Any suitable order of implementation can be used.

In an example, prior to performing (S1510), whether the transform type information is to be inherited by the current block is determined.

In an example, a first syntax element indicating that the transform type information is to be inherited by the current block may be encoded in the bitstream.

In an example, that the transform type information is to be inherited may be determined when multiple transform selection (MTS) is available to the current block.

In an example, the merge mode is an inter merge mode (e.g., the regular merge mode), the motion information of the merge candidate indicates an MV and a reference picture, and the reference picture is different from a current picture of the current block.

In an example, the merge mode is the IBC merge mode, and the merge candidate is from a neighboring IntraTMP block of the current block. The neighboring IntraTMP block is coded by an IntraTMP mode. The transform type information includes a transform type of the neighboring IntraTMP block, and the one of the motion information and the BV information includes a BV of the neighboring IntraTMP block.

In an example, that the transform type information of the merge candidate is included in the merge candidate list is determined when a block size of the current block satisfies a condition. The condition may include one of: (i) an area of the current block is larger than or equal to W₁×H₁, (ii) the area of the current block is smaller than or equal to W₂×H₂, (iii) a width of the current block is larger than or equal to W₃, (iv) the width of the current block is smaller than or equal to W₄, (v) a height of the current block is larger than or equal to H₃, and (vi) the height of the current block is smaller than or equal H₄.

In an example, when the transform type information is determined not to be inherited by the current block, a second syntax element that indicates a transform type of the current block may be encoded.

In an aspect, a method of processing visual media data includes processing a bitstream of visual media data including a current block according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

The bitstream includes coded information indicating that the current block is predicted according to a merge mode (e.g., any of the types or merge mode described above). The format rule may specify when transform type information is to be inherited by the current block, the transform type information of a merge candidate and one of motion information and block vector (BV) information of the merge candidate is added into a merge candidate list of the current block. The format rule specifies that the current block is reconstructed based on the merge candidate list. The merge candidate list includes the transform type information of the merge candidate and the one of the motion information and BV information of the merge candidate.

In an aspect, the bitstream includes a first syntax element indicating whether the transform type information is to be inherited by the current block that is predicted according to an inter merge mode such as the regular merge mode. The format rule specifies that when the transform type information is determined to be inherited by the current block and the MTS is available to the current block, the transform type information of the merge candidate and the motion information of the merge candidate is added into the merge candidate list of the current block. The current block is coded based on the merge candidate list.

In an example, the bitstream includes a second syntax element indicating a transform type of the current block. The format rule specifies that when the transform type information is determined not to be inherited by the current block, the current block is coded based on the transform type indicated by the second syntax element.

In an example, the motion information of the merge candidate indicates an MV and a reference picture, and the reference picture is different from a current picture of the current block.

In an example, the transform type information is determined to be inherited by the current block when one of (i) an area, (ii) a width, and (iii) a height of the current block satisfies a predefined condition.

Aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

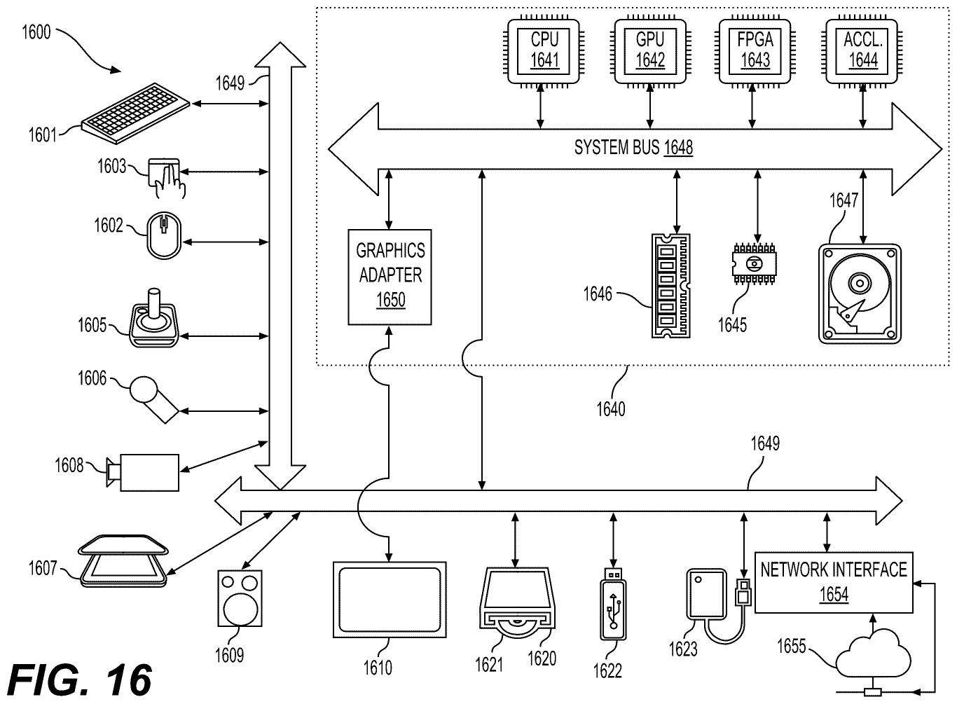

The techniques described above, can be implemented as computer software using computer-readable instructions and physically stored in one or more computer-readable media. For example, FIG. 16 shows a computer system (1600) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 16 for computer system (1600) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1600).

Computer system (1600) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1601), mouse (1602), trackpad (1603), touch screen (1610), data-glove (not shown), joystick (1605), microphone (1606), scanner (1607), camera (1608).

Computer system (1600) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1610), data-glove (not shown), or joystick (1605), but there can also be tactile feedback devices that do not serve as input devices), audio output devices (such as: speakers (1609), headphones (not depicted)), visual output devices (such as screens (1610) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1600) can also include human accessible storage devices and their associated media such as optical media including CD/DVD ROM/RW (1620) with CD/DVD or the like media (1621), thumb-drive (1622), removable hard drive or solid state drive (1623), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1600) can also include an interface (1654) to one or more communication networks (1655). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1649) (such as, for example USB ports of the computer system (1600)); others are commonly integrated into the core of the computer system (1600) by attachment to a system bus as described below (for example Ethernet interface into a PC computer system or cellular network interface into a smartphone computer system). Using any of these networks, computer system (1600) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1640) of the computer system (1600).

The core (1640) can include one or more Central Processing Units (CPU) (1641), Graphics Processing Units (GPU) (1642), specialized programmable processing units in the form of Field Programmable Gate Areas (FPGA) (1643), hardware accelerators for certain tasks (1644), graphics adapters (1650), and so forth. These devices, along with Read-only memory (ROM) (1645), Random-access memory (1646), internal mass storage such as internal non-user accessible hard drives, SSDs, and the like (1647), may be connected through a system bus (1648). In some computer systems, the system bus (1648) can be accessible in the form of one or more physical plugs to enable extensions by additional CPUs, GPU, and the like. The peripheral devices can be attached either directly to the core's system bus (1648), or through a peripheral bus (1649). In an example, the screen (1610) can be connected to the graphics adapter (1650). Architectures for a peripheral bus include PCI, USB, and the like.

CPUs (1641), GPUs (1642), FPGAs (1643), and accelerators (1644) can execute certain instructions that, in combination, can make up the aforementioned computer code. That computer code can be stored in ROM (1645) or RAM (1646). Transitional data can also be stored in RAM (1646), whereas permanent data can be stored for example, in the internal mass storage (1647). Fast storage and retrieve to any of the memory devices can be enabled through the use of cache memory, that can be closely associated with one or more CPU (1641), GPU (1642), mass storage (1647), ROM (1645), RAM (1646), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1600), and specifically the core (1640) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1640) that are of non-transitory nature, such as core-internal mass storage (1647) or ROM (1645). The software implementing various aspects of the present disclosure can be stored in such devices and executed by core (1640). A computer-readable medium can include one or more memory devices or chips, according to particular needs. The software can cause the core (1640) and specifically the processors therein (including CPU, GPU, FPGA, and the like) to execute particular processes or particular parts of particular processes described herein, including defining data structures stored in RAM (1646) and modifying such data structures according to the processes defined by the software. In addition or as an alternative, the computer system can provide functionality as a result of logic hardwired or otherwise embodied in a circuit (for example: accelerator (1644)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of”′ in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A non-transitory computer-readable storage medium storing instructions which when executed by a processor cause the processor to perform an encoding method comprising:
determining whether transform type information is to be inherited by a current block that is to be predicted according to a merge mode;
when the transform type information is determined to be inherited by the current block,
adding the transform type information of a merge candidate and one of motion information and block vector (BV) information of the merge candidate into a merge candidate list of the current block; and
encoding, in a bitstream, the current block based on the merge candidate list including the transform type information of the merge candidate and the one of the motion information and the BV information of the merge candidate; and
transmitting the encoded bitstream.

2. The non-transitory computer-readable storage medium of claim 1, wherein:
the determining comprises determining that the transform type information is to be inherited when multiple transform selection (MTS) is available to the current block.

3. The non-transitory computer-readable storage medium of claim 1, wherein the merge mode is an inter merge mode, the motion information of the merge candidate indicates a motion vector (MV) and a reference picture, and the reference picture is different from a current picture of the current block.

4. The non-transitory computer-readable storage medium of claim 1, wherein:
the merge mode is an intra block copy (IBC) merge mode;
the merge candidate is from a neighboring intra template matching prediction (IntraTMP) block of the current block, the neighboring IntraTMP block being coded by an IntraTMP mode,
the transform type information includes a transform type of the neighboring IntraTMP block, and
the one of the motion information and the BV information includes a BV of the neighboring IntraTMP block.

5. The non-transitory computer-readable storage medium of claim 1, wherein the transform type information is determined to be inherited by the current block when one of (i) an area, (ii) a width, and (iii) a height of the current block satisfies a predefined condition.

6. A method for video encoding, comprising:
determining whether transform type information is to be inherited by a current block that is to be predicted according to a merge mode, and
when the transform type information is determined to be inherited by the current block,
adding the transform type information of a merge candidate and one of motion information and block vector (BV) information of the merge candidate into a merge candidate list of the current block; and
encoding, in a bitstream, the current block based on the merge candidate list including the transform type information of the merge candidate and the one of the motion information and the BV information of the merge candidate.

7. The method of claim 6, wherein the determining comprises determining that the transform type information is to be inherited when multiple transform selection (MTS) is available to the current block.

8. The method of claim 6, wherein the merge mode is an inter merge mode, the motion information of the merge candidate indicates a motion vector (MV) and a reference picture, and the reference picture is different from a current picture of the current block.

9. The method of claim 6, wherein:
the merge mode is an intra block copy (IBC) merge mode;
the merge candidate is from a neighboring intra template matching prediction (IntraTMP) block of the current block, the neighboring IntraTMP block being coded by an IntraTMP mode,
the transform type information includes a transform type of the neighboring IntraTMP block, and
the one of the motion information and the BV information includes a BV of the neighboring IntraTMP block.

10. The method of claim 6, wherein the determining comprises determining that the transform type information of the merge candidate is included in the merge candidate list when one of (i) an area, (ii) a width, and (iii) a height of the current block satisfies a predefined condition.

11. The method of claim 6, further comprising:
encoding, in the bitstream, a first syntax element indicating that the transform type information is to be inherited by the current block.

12. The method of claim 6, further comprising:
encoding a first syntax element indicating whether the transform type information is to be inherited by the current block, and
when the transform type information is not to be inherited by the current block, encoding a second syntax element indicating a transform type of the current block.

13. The method of claim 12, wherein multiple transform selection (MTS) is available to the current block.

14. An apparatus for video decoding, comprising:
processing circuitry configured to:
receive coded information indicating that a current block is predicted according to a merge mode;
when transform type information is to be inherited by the current block, add the transform type information of a merge candidate and one of motion information and block vector (BV) information of the merge candidate into a merge candidate list of the current block; and
reconstruct the current block based on the merge candidate list, the merge candidate list including the transform type information of the merge candidate and the one of the motion information and the BV information of the merge candidate.

15. The apparatus of claim 14, wherein the transform type information of the merge candidate is included in the merge candidate list when multiple transform selection (MTS) is available to the current block.

16. The apparatus of claim 14, wherein the merge mode is an inter merge mode, the motion information of the merge candidate indicates a motion vector (MV) and a reference picture, and the reference picture is different from a current picture of the current block.

17. The apparatus of claim 14, wherein:
the merge mode is an intra block copy (IBC) merge mode;
the merge candidate is from a neighboring intra template matching prediction (IntraTMP) block of the current block, the neighboring IntraTMP block being coded by an IntraTMP mode;
the transform type information includes a transform type of the neighboring IntraTMP block; and
the one of the motion information and the BV information includes a BV of the neighboring IntraTMP block.

18. The apparatus of claim 14, wherein the transform type information of the merge candidate is included in the merge candidate list when one of (i) an area, (ii) a width, and (iii) a height of the current block satisfies a predefined condition.

19. The apparatus of claim 14, wherein:
the coded information includes a first syntax element indicating whether the transform type information is to be inherited by the current block, and
when the first syntax element indicates that the transform type information is not to be inherited by the current block,
the coded information includes a second syntax element indicating a transform type of the current block, and
the processing circuitry is configured to reconstruct the current block based on the transform type indicated by the second syntax element.

20. The apparatus of claim 19, wherein multiple transform selection (MTS) is available to the current block.
